(19) United States
(12) Patent Application Publication
(10) Pub. No.: US 2009/0034977 A1
(43) Pub. Date: Feb. 5, 2009

(54) MULTIPLEXING HIGH SPEED LIGHT EMITTING DIODES (LEDs)

(76) Inventors: Michael Renne Ty Tan, Menlo Park, CA (US); Shih-Yuan Wang, Palo Alto, CA (US); Alexandre M. Bratkovski, Mountain View, CA (US); Marco Fiorentino, Mountain View, CA (US); Raymond G. Beausoleil, Redmond, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/830,618

(22) Filed: Jul. 30, 2007

(51) Int. Cl. H04J 14/02

(52) U.S. Cl. 398/82

(57) ABSTRACT

A system for multiplexing a plurality of high speed light emitting diodes (HSLEDs) includes a plurality of HSLEDs. Each of the plurality of HSLEDs emits a wavelength of light at a speed greater than or equal to about 1 Gigabyte per second. A multiplexer receives the wavelengths of light from the plurality of HSLEDs and combines the wavelengths of light for transmission over a channel. A method of multiplexing the plurality of HSLEDs is also disclosed.

### BACKGROUND

Light emitting diodes (LEDs) have found utility in a variety of applications from common light sources, such as flashlights and automotive headlights, to photonic interconnects for data transmission. An LED is a semiconductor device that spontaneously emits a narrow spectrum of light when electrically biased in the forward direction of a p-n junction. Light is created in, and released from, the p-n junction, which is more commonly referred to as the active layer.

One drawback of conventional LEDs is that the relatively slow speed of the conventional LEDs renders them unsuitable for multiplexing. Multiplexing refers to combining the outputs of a plurality of LEDs, so that the plurality of outputs can be transmitted together on a single waveguide. Multiplexing is an efficient method of transmitting increased amounts of data over a single transmission medium, which makes excellent use of data transmission resources. Thus, multiplexing has become an essential aspect of data transmission.

However, multiplexing operates most effectively with high speed light sources. Therefore, the slow speed of conventional LEDs hinders their use in data transmission applications, because they cannot be efficiently multiplexed.

### BRIEF DESCRIPTION OF THE DRAWINGS

Features of the present invention will become apparent to those skilled in the art from the following description with reference to the figures, in which:

FIG. 1A illustrates a structure comprising an active layer having alternating quantum wells and modulation-doped layers, according to an embodiment;

FIG. 1B illustrates a structure comprising an active layer having alternating quantum wells and modulation-doped layers and electrodes, according to an embodiment;

FIG. 2 illustrates a structure comprising a textured surface facing an active layer, according to an embodiment;

FIG. 3 illustrates a structure comprising an active layer having alternating quantum wells and modulation-doped layers and a textured surface facing the active layer, according to an embodiment;

FIG. 4 illustrates a flow chart of a method for fabricating a structure comprising a textured surface facing an active layer, according to an embodiment;

FIG. 5 illustrates a flow chart of a method for fabricating a structure comprising an active layer having at least one modulation-doped layer and at lease one quantum well, according to an embodiment;

FIG. 6A illustrates a system for multiplexing high speed LEDs (HSLEDs), according to an embodiment;

FIG. 6B illustrates a system for multiplexing HSLEDs, according to another embodiment;

FIG. 6C illustrates a system for multiplexing HSLEDs, according to another embodiment; and

FIG. 7 illustrates a flow chart of a method for multiplexing HSLEDs, according to an embodiment.

### DETAILED DESCRIPTION

For simplicity and illustrative purposes, the present invention is described by referring mainly to exemplary embodiments. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Embodiments of systems for multiplexing high speed LEDs (HSLEDs) and methods for multiplexing HSLEDs are disclosed herein. The term HSLED refers to LEDs which emit light at a rate greater than about 1 Gigabyte per second (GB/s). For example, the HSLEDs described herein may emit light at, or above, 2 or 3 GB/s. Therefore, the outputs of the HSLEDs are capable of being efficiently multiplexed and are useful in high speed applications, such as photonic interconnects for data transmission.

As mentioned above, multiplexing refers to the process of combining the outputs of a plurality of HSLEDs and transmitting the combined outputs over a channel. The output of an HSLED is light and generally only a single wavelength of light or a narrow spectrum of wavelengths. Therefore, the channel is a transmission medium, which has the ability to propagate light. For example, the channel may comprise a waveguide, such as multilayered semiconductor devices, optical fibers formed from glass, plastics, etc., or the like. Alternatively, or in addition thereto, the channel may include free space, such as air. In one example, the channel may include a combination of waveguides and free space.

The HSLEDs described herein may have any reasonably suitable structure and may be formed from any reasonably suitable materials to create an LED capable of emitting light at speeds greater than about 1 GB/s. As mentioned above, an LED is a semiconductor device, which includes an active layer provided between a p-type layer and an n-type layer that spontaneously emits light when electrically biased in the forward direction of the active layer. The emission of light is spontaneous because photons are released as soon as carriers, such as electrons and holes, move through the active layer. That is, photons are emitted spontaneously to produce light when carriers enter the active layer. Thus, LEDs are distinguished from other forms of light producing devices, such as lasers, which, by definition, require stimulation to emit light. For instance, a laser requires a gain medium to stimulate the emission of light by transmitting a wavelength of light repeatedly through the gain medium. Therefore, lasers require devices not found in LEDs, such as feedback systems, to repeatedly redirect the wavelength of light through the gain medium. Moreover, LEDs often utilize elements not found in other forms of light-producing devices, such as lasers. For instance, LEDs commonly utilize a metal electrode having an opening through the metal electrode to allow light spontaneously generated in the active layer to escape through the opening.

The HSLEDs described herein may include a double heterostructure having multiple p-type layers and multiple n-type layers on either side of the active layer. According to an embodiment, a surface of one or more of the n-type layers and/or one or more of the p-type layers may be textured. Surfaces are textured by texturizing, which refers to the process of altering the surface of a layer from a substantially smooth or flat surface to a substantially non-flat surface. Textured surfaces may be substantially uniform having a regular repeating pattern or may be random and irregular, as will be described in greater detail below. The textured surface of one or more of the p- or n-type layers may be facing the active layer and, in other examples, may also be directly adjacent to the active layer.

According to another embodiment, the active layer of the structures includes at least one quantum well and at least one modulation-doped layer arranged in an adjacent and/or alternating relationship. A modulation-doped layer refers to a layer which has been modulation or pulsed doped such that the doping is applied in thin narrow bands. For example, an active layer may include a modulation-doped layer adjacent to a quantum well or a quantum well sandwiched between two modulation-doped layers or vice-versa. In other examples, the active layer may include two or more quantum wells and two or more modulation-doped layers, which are arranged in an alternating relationship, that is quantum well, modulation-doped layer, quantum well, modulation-doped layer, etc., as will be described in greater detail below. The modulation-doped layers may include any p- or n-type impurities, as is known in the art.

The textured surfaces and the active layers described above may be utilized separately, or in conjunction with each other, to increase the efficiency of an LED to create the HSLED. That is, the emission output of an LED may be improved with the examples described herein. For instance, the textured surface facing the active layer may increase extraction efficiency by reducing the internal reflection of the layer having the textured surface, thereby allowing light generated in the active layer to escape more efficiently. Thus, the speed of an LED may be increased to, or above, about 1 GB/s.

Similarly, an active layer having quantum wells and modulation-doped layers arranged in an alternating relationship also increases the light production efficiency of an LED. This is because the modulation-doped layers provide a source of carriers within the active layer, but the doping is not present in the quantum wells where the light is produced. Therefore, the modulation-doped layers do not negatively affect the speed at which photons are released.

The embodiments described herein allow for the creation of a HSLED with a reduced quantum lifetime, as compared to conventional LEDs, without sacrificing quantum efficiency. For example, as set forth above, the HSLEDs utilizing the structure and methods described herein may realize modulation speeds above about 1, 2, and 3 GB/s. Although, specific examples structures, which result in the creation of HSLEDs are described herein, a person having ordinary skill in the art will appreciate that other structures may be used in lieu of, or in combination with, the structures and methods described herein to create HSLEDs.

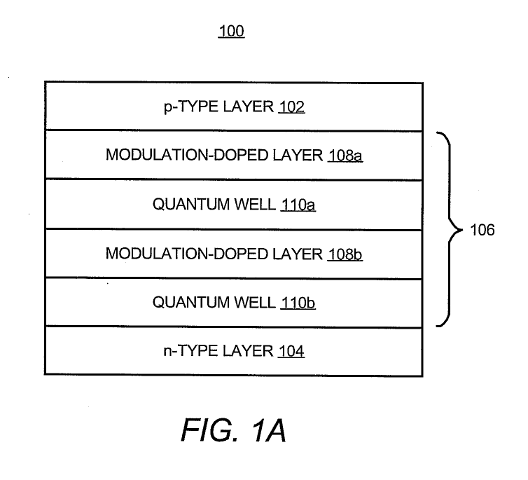

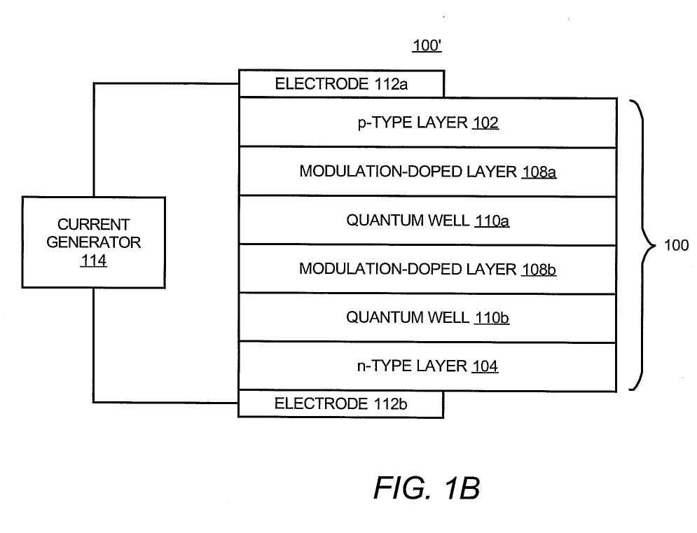

With respect to FIG. 1A, there is shown a structure 100 having an active layer 106 with alternating quantum wells 110a and 110b and modulation-doped layers 108a and 108b, according to an embodiment. It should be understood that the following description of the structure 100 is but one manner of a variety of different manners in which such a structure 100 may be configured. In addition, it should be understood that the structure 100 may include additional layers and devices not shown in FIG. 1A and that some of the layers described herein may be removed and/or modified without departing from a scope of the structure 100.

The active layer 106 of the structure 100 is provided between a p-type layer 102 and an n-type layer 104. The structure 100 may also comprise additional layers, such as cladding layers (not shown), commonly found in LEDs. For example, the p-type layer 102 and the n-type layers 104 may each include a plurality of layers to form a double heterostructure, as is known in the art. The structure 100 may also include any reasonably suitable substrates, electrodes, outer coverings, etc., which are commonly found in LEDs.

The p-type layer 102 and the n-type layer 104 may comprise any materials known in the art, such as GaN, AlGaN, ZnO, HgSe, ZnTeSe, ZnHgSe, ZnSe, AlGaAs, AlGaP, AlGaInP, GaAsP, GaP, InGaN, SiC, AlN etc. Moreover, although the p-type layer 102 and the n-type layer 104 are illustrated as single layers, respectively, a person having ordinary skill in the art will appreciate that the p-type layer 102 and the n-type layer 104 may each comprise more than one layer, as set forth above.

The active layer 106 is illustrated as including two modulation-doped layers 108a and 108b and two quantum wells 110a and 110b. However, the active layer 106 may include any reasonably suitable number of modulation-doped layers and 108b and quantum wells 110a and 110b. For example, the active layer 106 may include only one modulation-doped layer 108a and only one quantum well 110a, two modulation-doped layers 108a and 108b and one quantum well 110a, two quantum wells 110a and 110b and one modulation-doped layer 108a, more than two modulation-doped layers 108a and 108b, and more than two quantum wells 110a and 110b. Moreover, the modulation-doped layers 108a and 108b and the quantum wells 110a and 110b may be arranged in any order or configuration. For instance, either a modulation-doped layer 108a or a quantum well 110a may be positioned adjacent to the p-type layer 102 or the n-type layer 104. The modulation-doped layers 108a and 108b may include any known p-type or n-type doping material.

In an embodiment, the modulation-doped layers 108a and 108b and the quantum wells 110a and 110b may be arranged adjacent to each other when the active layer 106 includes only a single modulation-doped layer 108a and a single quantum well 110a or arranged in an alternating configuration, as shown in FIG. 1A. That is, the active layer 106 may be configured such that the modulation-doped layer 108a is adjacent to the quantum well 110a, while the opposite surface of the quantum well 110a is adjacent to another modulation-doped layer 108b and the opposite surface of the modulation-doped layer 108b is adjacent to another quantum well 110b, etc. In this manner, light may be generated inside the quantum wells 110a and 110b unimpeded by the deleterious effects of doping impurities. Yet the quantum wells 110a and 110b are provided with a sufficient source of carriers by virtue of their proximity to the modulation-doped layers 108a and 108b.

With respect to FIG. 1B, there is shown a structure 100′, which includes the structure 100, shown in FIG. 1A with additional components used to generate light, according to an embodiment. It should be understood that the following description of the structure 100′ is but one manner of a variety of different manners in which such a structure 100′ may be configured. In addition, it should be understood that the structure 100′ may include additional layers and devices not shown in FIG. 1B and that some of the layers described herein may be removed and/or modified without departing from a scope of the structure 100′.

In FIG. 1B, the structure 100 is shown having two electrodes 112a and 112b in contact with the p-type layer 102 and the n-type layer 104, respectively. The electrodes 112a and 112b are connected to a current generator 114, which provides an electric current to the electrodes 112a and 112b and, thus, to the structure 100. As such, the structure 100′ may be used as a HSLED, because the current generator 114 may provide an electric current, which stimulates carriers to move into the active layer 106. It should be understood that the electrodes 112a and/or 112b may have openings therethrough to allow for the emission of light from the structure 100′. A person having ordinary skill in the art will also appreciate that the electrodes 112a and 112b may have different shapes, sizes, lengths, etc. than pictured in FIG. 1B and may be positioned on different layers of the structure 100.

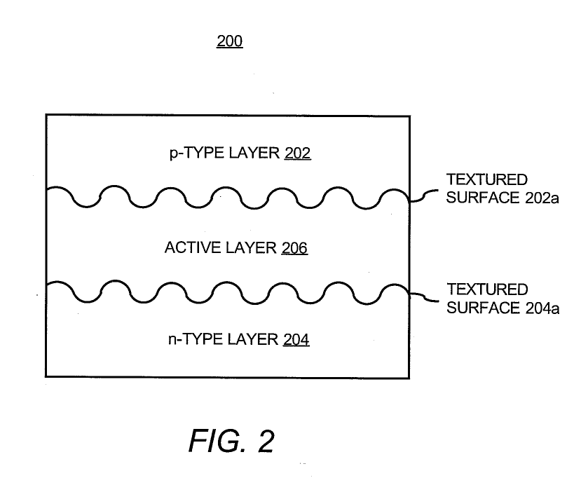

With respect to FIG. 2, there is shown a structure 200 having textured surfaces 202a and 204a facing an active layer 206, according to an embodiment. It should be understood that the following description of the structure 200 is but one manner of a variety of different manners in which such a structure 200 may be configured. In addition, it should be understood that the structure 200 may include additional layers and devices not shown in FIG. 2 and that some of the layers described herein may be removed and/or modified without departing from a scope of the structure 200.

The structure 200 includes a p-type layer 202 and an n-type layer 204, which may be substantially similar to the p-type layer 102 and the n-type layer 104 described above, with respect to FIG. 1A. For example, the p-type layer 202 and the n-type layer 204 may comprise more than one layer, respectively, to form a double heterostructure. The structure 200 also includes an active layer 206, which may be configured to allow carriers to flow therein to produce light. Therefore, the structure 200 may also be used in a HSLED to spontaneously produce light. As such, the structure 200 may include additional layers and devices (not shown), which are commonly found in LEDs.

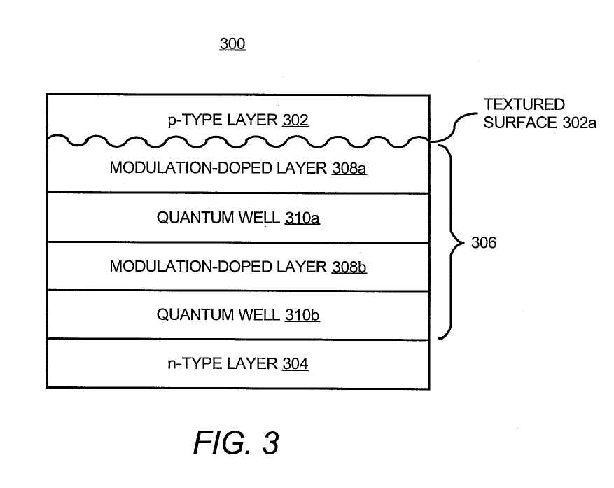

The active layer 206 of the structure 200 may comprise any material used in LEDs, such as quantum wells, multi-quantum wells, doped materials, etc. The active layer 206 may be a single modulation-doped layer or quantum well, or may be substantially similar to the active layer 106 described above with respect to FIG. 1A, which is also described in greater detail with respect to FIG. 3 below.

The p-type layer 202 and the n-type layer 204 are illustrated in FIG. 2 as having textured surfaces 202a and 204a, respectively, facing the active layer 206. That is, the p-type layer 202 and the n-type layer 204 each have at least two surfaces, one of which faces the active layer 206 and the other of which faces the opposite direction away from the active layer 206. In the structure 200, the surface of the p-type layer 202 and the n-type layer 204 facing the active layer 206 have textured surfaces 202a and 204a. Textured surfaces 202a and 204a refer to surfaces, which are substantially non-flat. The textured surfaces 202a and 204a are depicted as corrugated in a regular repeating pattern. However, the textured surfaces 202a and 204a may be corrugated in any irregular or random pattern. Moreover, the textured surfaces 202a and 204a need not be corrugated, but may be jagged and, roughened, patterned, or etched in any regular, irregular, or random pattern. In fact, the texturization may be affected by the angular distribution of the light emission incident at the interface of the active layer and the adjacent semiconductor layer, as well as the shape of this interface. As such, the textured surfaces 202a and 204a may be optimized for maximum light extraction efficiency depending on the type and shape of the various layers used to form the structure 200.

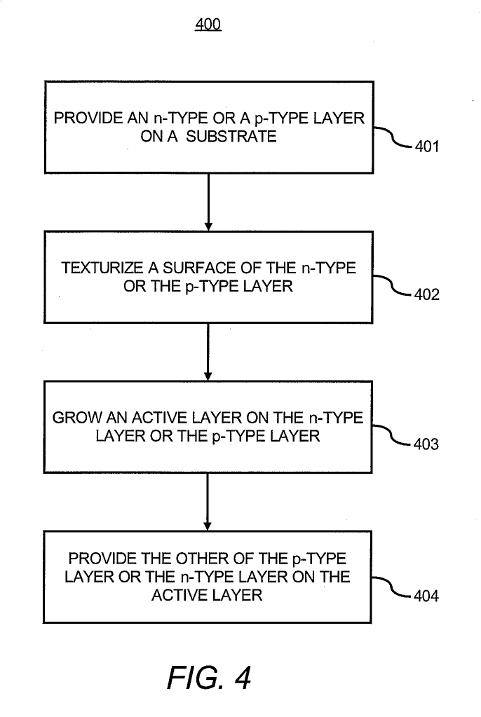

Although FIG. 2 depicts surfaces of both the p-type layer 202 and the n-type layer 204 as being textured, a person having ordinary skill in the art will appreciate that the structure 200 may include only one textured surface 204a. For example, a surface of either the n-type layer 204 or the p-type layer 202 may be texturized by a nanoimprinting process without texturizing any other surfaces. In another embodiment, one of the layers may be texturized and the other layers may be grown on the textured surface 204a of the texturized layer. This process may inherently result in the formation of two texturized surfaces, as described below with respect to FIG. 4.

As set forth above, providing textured surfaces 202a and 204a facing the active layer 206 increases the efficiency of light extraction from the active layer 206. For instance, the textured surfaces 202a and 204a may reduce lifetime. This is because light generated in the active layer 206 is trapped inside the active layer 206 due to the refractive index of the adjacent semiconductor layers, such as the p-type layer 202 and the n-type layer 204. Therefore, the light generated in the active layer 206 reflects off the surfaces of the adjacent semiconductor layers and back into the active layer 206. The textured surfaces 202a and 204a facing the active layer 206 randomize the direction of light coming out of active region 206 as opposed to isotropic light emission. Thus, the textured surfaces 202a and 204a reduce total internal reflection and enhance the extraction efficiency of the light generated in the active layer 206

With respect to FIG. 3, there is shown a structure 300 having an active layer 306 with alternating quantum wells 310a and 310b and modulation-doped layers 308a and 308b and a textured surface 302a facing the active layer 306. It should be understood that the following description of the structure 300 is but one manner of a variety of different manners in which such a structure 300 may be configured. In addition, it should be understood that the structure 300 may include additional layers and devices not shown in FIG. 3 and that some of the layers described herein may be removed and/or modified without departing from a scope of the structure 300.

The structure 300 includes a p-type layer 302 and an n-type layer 304, which may be substantially similar to the p-type layer 102 and the n-type layer 104 described above, with respect to FIG. 1A. For example, the p-type layer 302 and the n-type layer 304 may comprise more than one layer, respectively, to form a double heterostructure. The structure 300 includes the active layer 306 and, thus, the structure 300 may also be used in a HSLED. As such, the structure 300 may include additional layers and devices (not shown), which are commonly found in LEDs.

The active layer 306 of the structure 300 is substantially similar to the active layer 106, described with respect to FIG. 1A. As such, the active layer 306 includes two modulation-doped layers 308a and 308b and two quantum wells 310a and 310b arranged in an alternating configuration. The textured surface 302a of the p-type layer 302 may be substantially similar to the textured surface 202a, described with respect to FIG. 2. Therefore, the structure 300 may include the active region 306 to provide enhanced light generation efficiency and the textured surface 302a to provide enhanced light extraction efficiency, thereby improving the overall efficiency and speed of an LED utilizing the structure 300 to create a HSLED.

Turning now to FIG. 4, there is shown a flow diagram of a method 400 for fabricating a structure having a textured surface facing an active layer, according to an embodiment. It is to be understood that the following description of the method 400 is but one manner of a variety of different manners in which an example of the invention may be practiced. It should also be apparent to those of ordinary skill in the art that the method 400 represents a generalized illustration and that other steps may be added or existing steps may be removed, modified or rearranged without departing from a scope of the method 400.

The description of the method 400 is made with reference to the structure 200 illustrated in FIG. 2 and thus makes reference to the elements cited therein. It should, however, be understood that the method 400 is not limited to the layers set forth in the structure 200. Instead, it should be understood that the method 400 may be used with a structure having a different configuration than the structure 200 set forth in FIG. 2.

The method 400 may be initiated at step 401 where either an n-type layer 204 or a p-type layer 202 is provided. For example, the n-type layer 204 or the p-type layer 202 may be grown or otherwise provided on a substrate using known growth techniques such as molecular beam epitaxy (MBE), metalorganic chemical vapor deposition (MOCVD), atomic layer epitaxy (ALE), etc. The substrate may be any material known in the art for forming LEDs, such as a semiconductor material, silicon carbide (SiC), Silicon (Si), Sapphire (Al₂O₃), etc. Similarly, the n-type layer 204 or the p-type layer 202 may comprise any reasonably suitable n-type or p-type semiconductor material known in the art.

At step 402, a surface of the n-type layer 204 or a p-type layer 202 layer is texturized to form a textured surface 204a. The surface of the n-type layer 204 or the p-type layer 202 may be texturized by any process known in the art including nanoimprinting, nanolithography, etc. to have any substantially non-flat profile. For example, the surface of the n-type layer 204 or the p-type layer 202 may be texturized in a random or regular corrugation pattern. The textured surface 204a may be optimized depending on the types of materials used to form the various layers of the structure 200 and the shapes of the layers, as set forth above.

At step 403, an active layer 206 is grown on the textured surface 204a of the n-type layer 204 or the p-type layer 202. The active layer 206 may be grown by any of the methods described above and may include one or more layers and one or more different types of materials. For example, the active layer 206 may include a plurality of modulation-doped layers and a plurality of quantum wells arranged in an alternating configuration. Because the active layer 206 is grown on the textured surface 204a of the n-type layer 204 or the p-type layer 202, the resulting structure comprises a textured layer 204a facing the active layer 206 and also, in this example, adjacent to the active layer 206.

At step 404, the other of the n-type layer 204 or the p-type layer 202 is provided on the active layer 206 by any method known in the art, including those described above. The phrase “the other of the n-type layer 204 or the p-type layer 202” refers to the layer, which was not used in step 401. That is, if the n-type layer 204 is used in step 401, then the p-type layer 202 is used here in step 404. In one example, the other of the n-type layer 204 or the p-type layer 202 may inherently have a textured surface 202a facing, and adjacent to, the active layer 206. This occurs when the opposite surface of the active layer 206 from the n-type layer 204 or the p-type layer 202 is textured as a result of being grown on the textured surface of the n-type layer 204. That is, growing an active layer 206 on a textured surface 204a may, in some examples, result in an active layer 206 having two textured surfaces. Therefore, when the other of the p-type layer 202 or the n-type layer 204 is grown on the textured surface of the active layer, the other of the p-type layer 202 or the n-type layer 204 will have a textured surface 202a at the interface of the other of the p-type layer 202 or the n-type layer 204 and the active layer 206. Although not illustrated, the method 400 may also include additional texturing steps performed on the active layer 206 or the other of the p-type layer 202 or the n-type layer before the layers are joined together to form the structure 200.

The resulting structure 200 may be used in a HSLED, as the active layer 206 may be configured to spontaneously release photons to produce light when carriers move into the active layer 206 upon the application of an electric current. Therefore, the method 400 may include additional steps not illustrated in FIG. 4. For example, the method 400 may include providing additional n-type layers or p-type layers before growing the active layer 206 and providing additional p-type layers or n-type layers after growing the active layer 206. Moreover, the method 400 may include providing metal electrodes and creating an opening in the metal electrodes to allow for the emission of light generated in the active layer 206. The method 400 may also include spontaneously creating light in the active layer 206 by electrically biasing the structure to cause a movement of carriers into the active layer 206 and emitting the light at a high rate of speed, such as above about 1 G B/s.

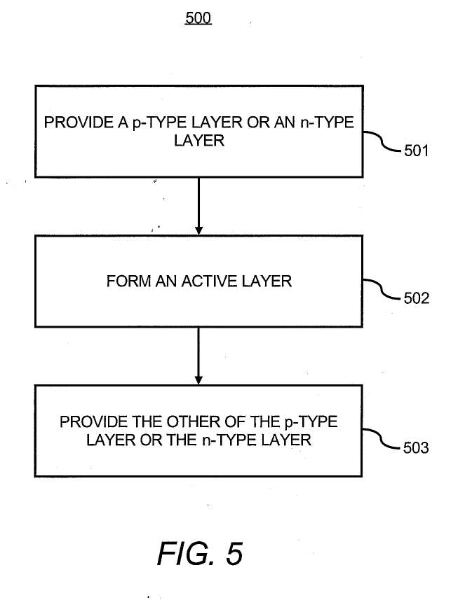

Turning now to FIG. 5, there is shown a flow diagram of a method 500 for fabricating a structure comprising an active layer having at least one quantum well and at least one modulation-doped layer, according to an embodiment. It is to be understood that the following description of the method 500 is but one manner of a variety of different manners in which an example of the invention may be practiced. It should also be apparent to those of ordinary skill in the art that the method 500 represents a generalized illustration and that other steps may be added or existing steps may be removed, modified or rearranged without departing from a scope of the method 500.

The description of the method 500 is made with reference to the structures 100 and 100′ illustrated in FIGS. 1A and 1B and thus makes reference to the elements cited therein. It should, however, be understood that the method 500 is not limited to the layers set forth in the structures 100 and 100′. Instead, it should be understood that the method 500 may be used with a structure having a different configuration than the structures 100 and 100′ set forth in FIGS. 1A and 1B.

The method 500 may be initiated at step 501 where either an n-type layer or a p-type layer is provided. The n-type or p-type layer may be grown or otherwise provided on a substrate.

At step 502, an active layer 106 is formed. The active layer 106 may include at least one modulation-doped layer 108a and at least one quantum well 110a. For example, the active layer 106 may include two or more modulation-doped layers 108a and 108b and two or more quantum wells 110a and 110b arranged in an alternating configuration. At step 503, the other of the p-type layer 102 or the n-type layer 104 may be provided on the active layer 106.

The structures and method described herein may be further modified to increase the efficiency of the HSLEDs. For example, the HSLEDs utilizing the structures described herein may comprise a surface grating to direct light emitting from the active layer 106, 206, 306. The surface grating may include resonant grating filters (RGFs). RGFs generally include a plurality of homogenous dielectric layers combined with a grating and may exhibit an extremely narrow reflection spectral band, which would otherwise require a large number of uniform layers. Therefore, RGFs are well suited to free space filtering applications. The working principle of a reflection RGF, or guided-mode resonance filter, is that a part of the incoming light is trapped in the waveguide via evanescent grating coupling. When coupling back out, the trapped light interferes destructively with the incoming light within a very limited range of parameters, similar to a resonance condition. Outside this resonance region the light does not couple into the waveguide and is transmitted and reflected as from a regular stratified layer.

Reflection or transmission filters may also be used to form HSLEDs with the structures and methods described herein. In reflection filters, only a small part of the spectrum is reflected and the rest is transmitted. With reflection filters it may be easier to realize broadband transmission than broadband reflection using only a few homogenous layers. Tunability of reflection filters is based on the change of the resonance wavelength as function of the angle of incidence. Thus, by tilting the HSLED, the narrow reflection band can be shifted through the whole tuning range.

In other embodiments, the capacitance of the structures described herein and HSLEDs utilizing the structures described herein may be reduced. For example, capacitance may be reduced by reducing the overall size of the structures and the HSLEDs using the structures. For instance the structures may be reduced to a size of less than about 70 microns. In one example, the structures may have a size of about 10 microns. This may, in turn, reduce the RC time constant of the HSLEDs to further increase the modulation speed of the HSLEDs. The textured surfaces and the active layers described above may be utilized separately, or in conjunction with each other, to increase the efficiency of a HSLED. That is, the emission output of a HSLED may be improved with the examples described herein. For instance, the textured surface facing the active layer may increase extraction efficiency by reducing the internal reflection of the layer having the textured surface, thereby allowing light generated in the active layer to escape more efficiently.

The various structure and method described herein may be used alone or in conjunction with each other and other structures, devices, and method to create a more efficient HSLED, as compared to conventional LEDs. For example, HSLEDs utilizing the structure and methods described herein may realize modulation speeds at, or above, about 1, 2, and 3 GB/s. Thus, the increased modulation speed renders the HSLEDs highly suitable for high speed applications, as photonic interconnects for data transmission in computing applications. Moreover, while specific examples of structures and methods, which may be used to create HSLEDs have been described herein, a person having ordinary skill in the art will appreciate that other structures and methods may also be used to create HSLEDs.

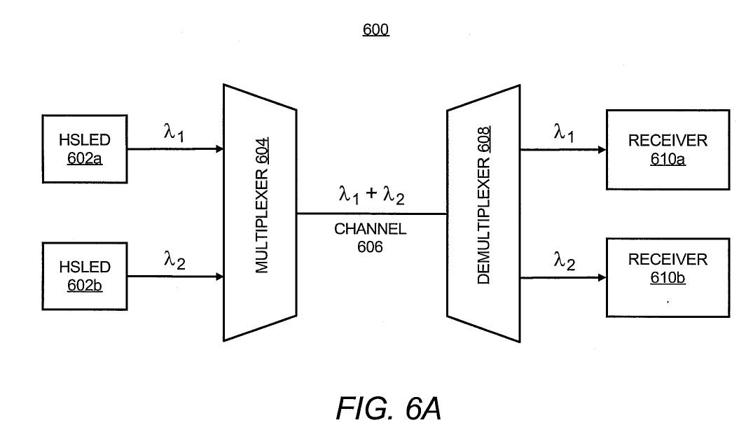

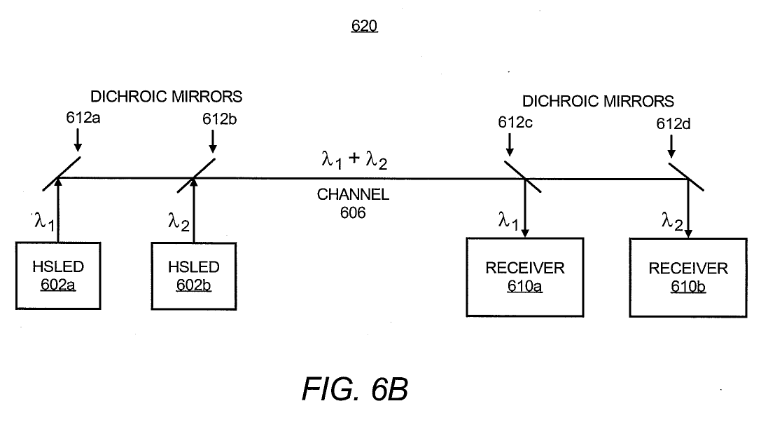

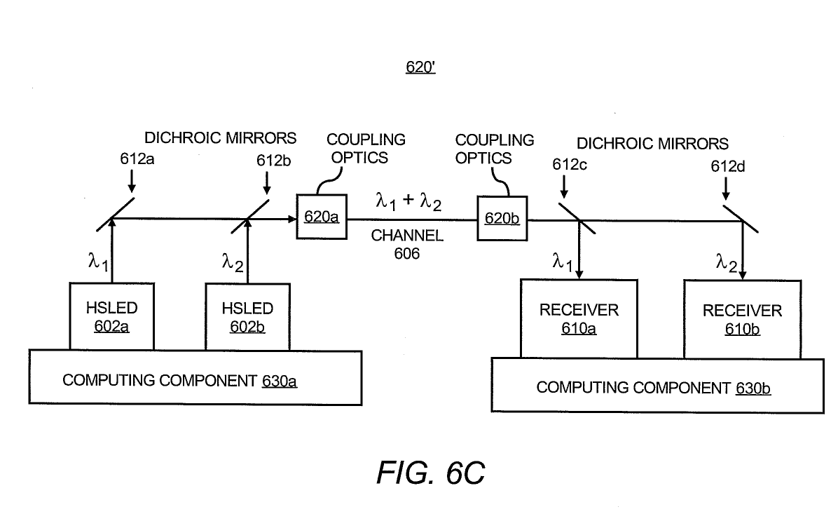

With respect to FIG. 6A, there is shown a block diagram of a generalized system 600 for multiplexing HSLEDs, according to an embodiment. It should be understood that the following description of the system 600 is but one manner of a variety of different manners in which such a system 600 may be configured. In addition, it should be understood that the system 600 may include additional components and devices not shown in FIG. 6 and that some of the components described herein may be removed and/or modified without departing from a scope of the system 600.

The system 600 includes a plurality of HSLEDs 602a and 602b, which may comprise one or more of the structures described above. Although only two HSLEDs 602a and 602b are shown in FIG. 6A, a person having ordinary skill in the art will appreciate that the system 600 may include any reasonably suitable number of HSLEDs. The HSLEDs 602a and 602b emit light at different wavelengths designated as “λ₁” and “λ₂,” respectively, which may comprise a single wavelength or a narrow spectrum of wavelengths. Because λ₁ and λ₂ are emitted from the HSLEDs 602a and 602b, λ₁ and λ₂ propagate at speeds at, or above, about 1 GB/s and are received by a multiplexer 104. The multiplexer 604 comprises any reasonably suitable device or components for combining different sources of light into a single transmission. For example, the multiplexer 604 may include beam splitters, dichroic mirrors and other devices used in wavelength division multiplexing (WDM) and course wavelength division multiplexing (CWDM).

The combined λ₁ and λ₂ is transmitted over a channel 606 to a demultiplexer 608. The channel 606 may be any medium for propagating light, such as free space, fiber optical cables, glass, plastics, etc. The demultiplexer 608 may include any devices or components for separating a single input into multiple outputs and may include any of the devices or components used in the multiplexer 604. In fact, the demultiplexer 608 may be a mirror image of the multiplexer 604. That is, the multiplexer 604 may include a prism orientated in a particular direction, while the demultiplexer 608 may include a similar prism oriented in substantially the opposite direction.

The demultiplexer 608 outputs the separated λ₁ and λ₂ to receivers 610a and 610b, respectively, which may receive and further process, route, analyze, etc. λ₁ and λ₂. For example, the receivers 610a and 610b may include photodiodes and other photodetectors. Although FIG. 6A shows two different receivers 610a and 610b, a person having ordinary skill in the art will appreciate that the system 600 may include any reasonably suitable number of receivers. For example, the system 600 may include only a single receiver, which is capable of receiving multiple inputs from the demultiplexer 608. Alternatively, the system 600 may include more than two receivers or a corresponding receiver for each HSLED used in the system 600.

With respect to FIG. 6B, there is shown a block diagram of a system 620 for multiplexing HSLEDs, according to another embodiment. It should be understood that the following description of the system 620 is but one manner of a variety of different manners in which such a system 620 may be configured. In addition, it should be understood that the system 620 may include additional components and devices not shown in FIG. 6B and that some of the components described herein may be removed and/or modified without departing from a scope of the system 620.

The system 620 includes a plurality of HSLEDs 602a and 602b, which are substantially similar to the HSLEDs 602a and 602b described above, with respect to FIG. 6A and, thus, may comprise one or more of the structures described above. Although only two HSLEDs 602a and 602b are shown in FIG. 6B, a person having ordinary skill in the art will appreciate that the system 620 may include any reasonably suitable number of HSLEDs 602a and 602b. The HSLEDs 602a and 602b emit light at different wavelengths designated as “λ₁” and “λ₂,” respectively, which may comprise a single wavelength or a narrow spectrum of wavelengths. Because λ₁ and λ₂ are emitted from the HSLEDs 602a and 602b, λ₁ and λ₂ propagate at speeds at, or above, about 1 GB/s and may contact dichroic mirrors 612a and 612b, respectively.

The dichroic mirrors 612a and 612b are filters for selectively passing specific wavelengths of light and reflecting other wavelengths. For example, the dichroic mirror 612a is configured to reflect λ₁ while the dichroic mirror 612b is configured to reflect λ₂ and allow λ₁ to pass therethrough. The dichroic mirrors 612a and 612b are provided at a particular angle to redirect the reflected wavelengths of light, λ₁ and λ₂, towards a channel 606. In this manner, the combination of dichroic mirrors 612a and 612b acts as a multiplexer to combine multiple inputs, which are emitted from the HSLEDs 602a and 602b, into a single transmission, which is propagated over the channel 606. In FIG. 6B, the dichroic mirrors 612a-d are depicted as being angled at approximately 45 degrees. However, a person having ordinary skill in the art will appreciate that the dichroic mirrors 612a-d may be positioned at any reasonably suitable angle.

The transmission of λ₁ and λ₂ over the channel 606 contacts dichroic mirrors 612c and 612d. Dichroic mirror 612c is configured to reflect λ₁ and allow λ₂ to pass therethrough, while dichroic mirror 612d is configured to reflect λ₂. In this manner, the combination of dichroic mirrors 612c and 612d may act as a demultiplexer for separating λ₁ and λ₂ into individual outputs. The dichroic mirrors 612c and 612d are positioned to redirect λ₁ and λ₂ towards receivers 610a and 610b, respectively. The embodiment described herein FIG. 6B represents a low cost and effective method of multiplexing a plurality of HSLEDs. The components used in the system 620, such as the dichroic mirrors 612a-d and the channel 606, may comprise free space and/or low cost materials, such as dyed, or otherwise colored, glasses and plastics.

With respect to FIG. 6C, there is shown a block diagram of a system 620′ for multiplexing HSLEDs, according to another embodiment. It should be understood that the following description of the system 620′ is but one manner of a variety of different manners in which such a system 620′ may be configured. In addition, it should be understood that the system 620′ may include additional components and devices not shown in FIG. 6C and that some of the components described herein may be removed and/or modified without departing from a scope of the system 620′.

The system 620′ is substantially similar to the system 620 depicted in FIG. 6B and includes a plurality of HSLEDs 602a and 602b, which are substantially similar to the HSLEDs 602a and 602b described above, with respect to FIGS. 6A and 6B and, thus, may comprise one or more of the structures described above. The HSLEDs 602a and 602b are depicted as associated with a computing component 630a. The computing component 630a may be a device or combination of devices for generating and/or transmitting data, such as a circuit board or the like. Although only two HSLEDs 602a and 602b are shown in FIG. 6C, a person having ordinary skill in the art will appreciate that the system 620′ may include any reasonably suitable number of HSLEDs 602a and 602b. The HSLEDs 602a and 602b emit light at different wavelengths designated as “λ₁” and “λ₂,” respectively, which may comprise a single wavelength or a narrow spectrum of wavelengths. Similarly, the system 620′ may include more than one computing component 630a. For example, each of the HSLEDs 602a may be associated with an individual computing component 630a. Because λ₁ and λ₂ are emitted from the HSLEDs 602a and 602b, λ₁ and λ₂ propagate at speeds at, or above, about 1 GB/s and may contact dichroic mirrors 612a and 612b, respectively. The light emitted from the HSLEDs 602a and 602b may be used to transmit information from the computing component 630a.

The dichroic mirrors 612a and 612b are filters for selectively passing specific wavelengths of light and reflecting other wavelengths. For example, the dichroic mirror 612a is configured to reflect λ₁ while the dichroic mirror 612b is configured to reflect λ₂ and allow λ₁ to pass therethrough. The dichroic mirrors 612a and 612b are provided at a particular angle to redirect the reflected wavelengths of light, λ₁ and λ₂, towards a channel 606. In this manner, the combination of dichroic mirrors 612a and 612b act as a multiplexer to combine multiple inputs, which are emitted from the HSLEDs 602a and 602b, into a single transmission, which is propagated over the channel 606. In FIG. 6B, the dichroic mirrors 612a-d are depicted as being angled at approximately 45 degrees. However, a person having ordinary skill in the art will appreciate that the dichroic mirrors 612a-d may be positioned at any reasonably suitable angle.

Before λ₁ and λ₂ are transmitted into and out of the channel 606 they pass through coupling optics 620a and 620b, respectively. The coupling optics 620a and 620b may include a device or combination of devices for focusing light. For example, when the channel 606 includes free space, the coupling optics 620a and 620b may comprise a broadband collimator. Similarly, when the channel 606 includes a waveguide, the coupling optics may include a focusing lens. In fact, the coupling optics 620a and 620b may include miniaturized versions of conventional camera lens, which may be dyed or otherwise colored.

The transmission of λ₁ and λ₂ over the channel 606 contacts dichroic mirrors 612c and 612d. Dichroic mirror 612c is configured to reflect λ₁ and allow λ₂ to pass therethrough, while dichroic mirror 612d is configured to reflect λ₂. In this manner, the combination of dichroic mirrors 612c and 612d may act as a demultiplexer for separating λ₁ and λ₂ into individual outputs. The dichroic mirrors 612c and 612d are positioned to redirect λ₁ and λ₂ towards receivers 610a and 610b, respectively, which are associated with a computing component 630b. The computing component 630b may be any electronic device, such as a circuit board.

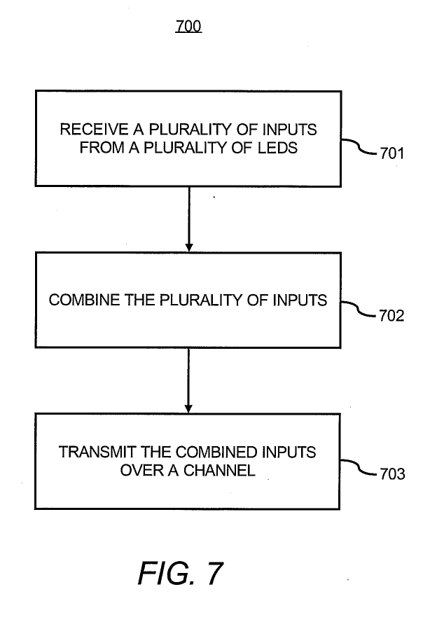

Turning now to FIG. 7, there is shown a flow diagram of a method 700 for multiplexing HSLEDs, according to an embodiment. It is to be understood that the following description of the method 700 is but one manner of a variety of different manners in which an example of the invention may be practiced. It should also be apparent to those of ordinary skill in the art that the method 700 represents a generalized illustration and that other steps may be added or existing steps may be removed, modified or rearranged without departing from a scope of the method 700.

The description of the method 700 is made with reference to the systems 600, 620, and 620′ illustrated in FIGS. 6A, 6B, and 6C and thus makes reference to the elements cited therein. It should, however, be understood that the method 700 is not limited to the layers set forth in the systems 600, 620, and 620′. Instead, it should be understood that the method 700 may be used with systems having a different configuration than the systems 600, 620, and 620′ set forth in FIGS. 6A, 6B, and 6C.

The method 700 may be initiated at step 701 where a plurality of inputs are received. The plurality of inputs include a wavelength of light emitted from a plurality of HSLEDs 602a and 602b at a speed greater than or equal to about 1 GigaByte per second. For example, the plurality of HSLEDs 602a and 602b may each emit a different wavelength of light, or narrow spectrum of wavelengths, such as λ₁ and λ₂. The wavelengths of light, λ₁ and λ₂, may be received by a multiplexer 604. In one example, the multiplexer 604 may include a dichroic mirror 612b or a combination of dichroic mirrors 612a and 612b. The plurality of wavelengths of light, λ₁ and λ₂, may be received substantially simultaneously or at different times.

At step 702, the wavelengths of light, λ₁ and λ₂, are combined for transmission over a channel 606. For example, the dichroic mirror 612b may reflect, and redirect, λ₂ towards the channel 606 while allowing λ₁ to pass therethrough to the channel 606.

At step 703, the plurality of inputs are transmitted over the channel 606. Although not illustrated, the method 700 may include demultiplexing and further processing, routing, analyzing, detecting, etc. the wavelengths of light. For example, λ₁ and λ₂ may be received by a demultiplexer 608, which may include dichroic mirrors 612c and 612d. The demultiplexer 608 may separate λ₁ and λ₂ and redirect the individual wavelengths to receivers 610a and 610b.

What has been described and illustrated herein are preferred examples of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims and their equivalents in which all terms are meant in their broadest reasonable sense unless otherwise indicated.

What is claimed is:

1. A system for multiplexing a plurality of high speed light emitting diodes (HSLEDs) comprising:
the plurality of HSLEDs, wherein each of the plurality of HSLEDs emits a wavelength of light at a speed greater than or equal to about 1 Gigabyte per second; and
a multiplexer which receives the wavelengths of light from the plurality of HSLEDs and combines the wavelengths of light for transmission over a channel.

2. The system of claim 1, wherein the channel is at least one selected from free space and a waveguide configured to propagate the combined wavelengths of light.

3. The system of claim 1, further comprising:
a demultiplexer which separates the combined wavelengths of light into the wavelengths emitted by the plurality of HSLEDs.

4. The system of claim 3, further comprising:
at least one receiver for receiving the separated wavelengths of light.

5. The system of claim 1, wherein the multiplexer includes at least one dichroic mirror.

6. The system of claim 1, wherein the plurality of HSLEDs are configured to emit different wavelengths of light from the demultiplexer.

7. The system of claim 1, further comprising:
a current generator operable to electrically bias the plurality of HSLEDs to spontaneously generate light in an active layer of the plurality of HSLEDs upon a movement of carriers into the active layer.

8. The system of claim 1, wherein at least one of the HSLEDs comprises:
an active layer having a plurality of modulation-doped layers and a plurality of quantum wells arranged in an alternating configuration.

9. The system of claim 1, wherein at least one of the HSLEDs comprises:
a texturized surface at an interface of the active layer and either a p-type layer or an n-type layer.

10. A method of multiplexing a plurality of high speed light emitting diodes (HSLEDs) comprising:
receiving a plurality of inputs from the plurality of HSLEDs, wherein each of the plurality of inputs includes a wavelength of light emitted from the plurality of HSLEDs at a speed greater than or equal to about 1 Gigabyte per second;
combining the plurality of inputs for transmission over a channel; and
transmitting the plurality of combined inputs over the channel.

11. The method of claim 10, further comprising:
receiving the transmitted combined inputs at a demultiplexer; and
separating the combined inputs into the wavelengths of light emitted from the plurality of HSLEDs.

12. The method of claim 10, wherein receiving a plurality of inputs from the plurality of HSLEDs comprises:
receiving a plurality of different wavelengths of light from the plurality of HSLEDs.

13. The method of claim 10, wherein receiving a plurality of inputs from the plurality of HSLEDs comprises:
receiving the plurality of inputs at a multiplexer which includes at least one dichroic mirror.

14. The method of claim 10, further comprising:
electrically biasing the plurality of HSLEDs to spontaneously generate light in an active layer of the plurality of HSLED upon a movement of carriers into the active layer.

15. The method of claim 10, wherein at least one of the plurality of HSLEDs comprises an active layer having a plurality of modulation-doped layers and a plurality of quantum wells arranged in an alternating configuration.

16. The method of claim 10, wherein at least one of the plurality of HSLEDs comprises a texturized surface at an interface of an active layer and either a p-type layer or an n-type layer.

17. The method of claim 10, wherein the channel includes at least one selected from a waveguide and free space.

18. An interface for transmitting a plurality of wavelengths of light generated from a plurality of high speed light emitting diodes (HSLEDs) comprising:
the plurality of HSLEDs, wherein each of the plurality of HSLEDs is configured to emit the wavelengths of light at a speed greater than or equal to about 1 Gigabyte per second;
means for combining the wavelengths of light emitted from the plurality of HSLEDs; and
a channel configured to facilitate the transmission of the combined wavelengths of light.

19. The system of claim 18, wherein at least one of the plurality of HSLEDs comprises an active layer having plurality of modulation-doped layers and a plurality of quantum wells arranged in an alternating configuration.

20. The system of claim 18, wherein at least one of the plurality of HSLEDs comprises a texturized surface at an interface of an active layer and either a p-type layer or an n-type layer.
